(19) United States
(12) Patent Application Publication
(10) Pub. No.: US 2012/0126033 A1
(43) Pub. Date: May 24, 2012

(54) Portable spray rig

(76) Inventor: J. Craig Holworthy, Lindsay, CA (US)

(21) Appl. No.: 12/927,563

(22) Filed: Nov. 19, 2010

(51) Int. Cl. B05B 1/34

(52) U.S. Cl. 239/380

(57) ABSTRACT

A multi-purpose, portable spray rig, which also functions as a stationary unit including a vertically disposed propeller fan rotatable through 360 degrees to create a wind stream in the direction of a supporting tower. A tubular ring in a plane parallel to the wind stream created by the propeller. The tubular ring having a plurality of spray nozzles configured to inject a fine spray of water droplets into the wind stream resulting in a fine mist over a controlled area up to 300 or 400 feet in diameter, as the propeller rotates on a vertical axis through 360 degrees.

The present invention relates generally to spray rigs for agricultural use and which are both stationary and portable from location to location and, more particularly, to an assemblage which has particular, although not exclusive, utility in the cooling of farm animals.

### BACKGROUND OF THE INVENTION

1. Field of the Invention

In a large number of agricultural environments, particularly, although not exclusively, those below latitude 43° in the northern hemisphere, to summertime temperatures may often reach triple digits. The agricultural community is acutely aware that such temperatures, particularly when high temperatures persist for an extended period, result in considerable stress on dairy cows. Indeed, there is often a dramatic drop in milk production experienced, in addition to the deterioration of animal health. The natural and probable consequence of the referenced environment is significant diminution in income.

There are dairy oriented devices involving the distribution of water particulate, e.g, against a dairy cow's udder, primarily focused on the cleansing thereof. Similarly, in many feed lots static spray devices are employed to suppress dust, feed lots being almost entirely dirt.

2. Overview of the Prior Art

It is clear that misting devices employing a fan or the like to create a wind stream into which water particles are injected are known in the art. In the agricultural field, misting devices are often used to prevent citrus from freezing by spraying water at ground level where it freezes, thereby releasing heat into the atmosphere and thereby inhibiting destructively low temperatures. Citrus matures for harvest in the winter months, and that is when it is most vulnerable.

Everyone who has attended or watched football has become acquainted with the fans on the sidelines used to cool players.

Devices such as just described are also used in the summer months to keep cows cool, which enhances their milk production. While the underlying function is much the same in both uses, the mechanism is often quite different.

For example, Fergussen has been awarded a patent, U.S. Pat. No. 5,244,346, on a portable wind machine. The Fergussen unit was devised for an agricultural use, namely to dry crops which have been whetted by rains.

Nutt, on the other hand received design Pat. D205,559 on a portable wind machine for use in the field for frost protection.

Not all uses for wind machines are ag focused. For example Bois envisions [publication number 2010/00789842] such a machine for the purpose of creating renewable energy, primarily on an emergency basis, in the field. To the same effect, see Weesner et al. U.S. Pat. No. 7,105,940.

It will soon become apparent that the foregoing references are far afield from the present invention.

### SUMMARY OF THE INVENTION

The spray rig which is the soul of the present invention offers an opportunity to those engaged in agriculture to increase their respective bottom lines, particularly in the dairy business. It is demonstrable that dairy cows are more productive if their environment is more compatible with their comfort. Accordingly, it is an objective of the present invention to assist the dairyman in creating an environment in which his cows are optimally productive.

More specifically, a spray rig is provided which is effective as a fixed unit and portable to take advantage of windage and other topographical factors, while accomplishing the objectives attributable to it An objective related to the foregoing is to create a potable spray rig which is particularly efficient in the distribution of water particles over a vast area where cows inevitably congregate in anticipation of milking time.

Yet another objective of the present invention is to provide cooling in the range of 10 to 25 degrees F., while also removing amounts of ammonia and other fugitive emissions in the immediate area when used in a dairy yard environment.

The foregoing, as well as other objects and advantages of the present invention, will occur to those skilled in the art upon reading the following Detailed Description of a Preferred Embodiment, taken in conjunction with the drawings, wherein:

### BRIEF DESCRIPTION OF THE DRAWINGS

FIG. 1 is a pictorial view of the spray rig of the present invention, illustrating the interrelationship of the various elements thereof;

FIG. 2 is a top plan view of the upper reaches of the tower of the spray rig;

FIG. 3 is a view of a section of the upper, working end, of the tower of the spray rig of the present invention, showing the assemblage of working parts thereof; and,

FIG. 4 is an illustration of the spray rig of the present invention in operation, including the distribution of the water droplets as they are emitted from the spray nozzles.

### DESCRIPTION OF A PREFERRED EMBODIMENT

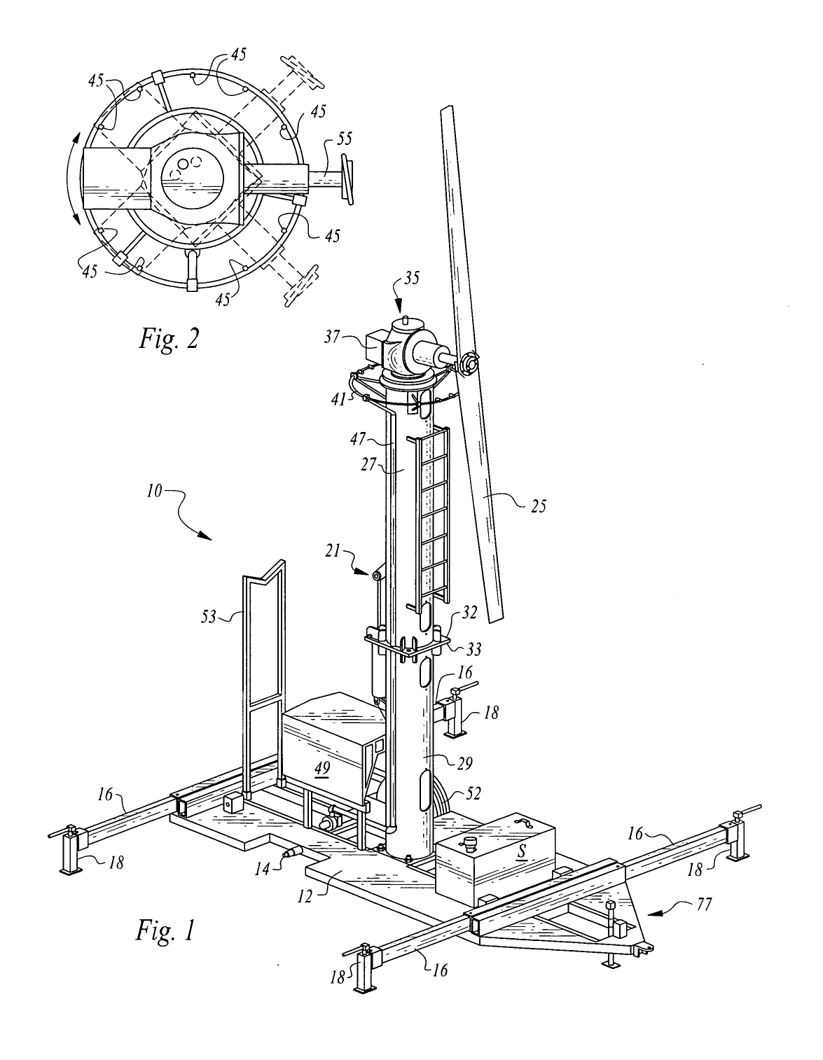

With reference now to the drawings, and initially to FIG. 1, a portable spray rig 10 is illustrated in some detail. The spray rig 10 is situate on a platform 12, which is configured in FIG. 1 for operation at a chosen location.

To this end, wheels may be removed, exposing spindles 14, and retractable outriggers 16 are extended outwardly, laterally of, and transversely to, the longitudinal axis of the platform 12. Each of the outriggers is equipped with levelers 18 depending from the remote ends thereof. The levelers are manually adjustable to level the platform which may be located on uneven terrain.

Still referring to FIG. 1, a tower 21 rises from the platform 12 where it is affixed by appropriate fasteners 23. The tower is of an appropriate height to accommodate a propeller 25 and is tubular in construction and, in order to enhance portability, is assembled in two parts, an upper tower element, or section, 27 and a base tower element, or section, 29. The sections are affixed with flanges 32, 33 which are fastened together in assembly.

In keeping with the objective attributable to the invention, the upper terminus 35 of the upper tower 27 is fitted with a rotatable transmission head 37. A stub shaft 39 extends laterally from the transmission head 35, and transverse to the tower axis. A propeller 25 is attached to the stub shaft 35 in a vertical orientation parallel to the tower.

The essence of the present invention is to provide a significant cooling effect over a wide area, e.g., barnyard or corral, and to do so with optimum efficiency with minimal expenditure of energy. As a means of optimizing the cooling effect, the present invention introduces a water spray into the airstream W created by the rotating propeller 25.

It is a principal feature of the present invention that it is able to place a controlled spray of water particles into an air stream capable of distributing, when appropriately sized, water particulate in a relatively uniform area of 300 to 400 feet in diameter. In order to accomplish this fete with optimum efficiency, the invention to contemplates the provision of a tubular ring 41 disposed to inject a uniform water spray into an air stream.

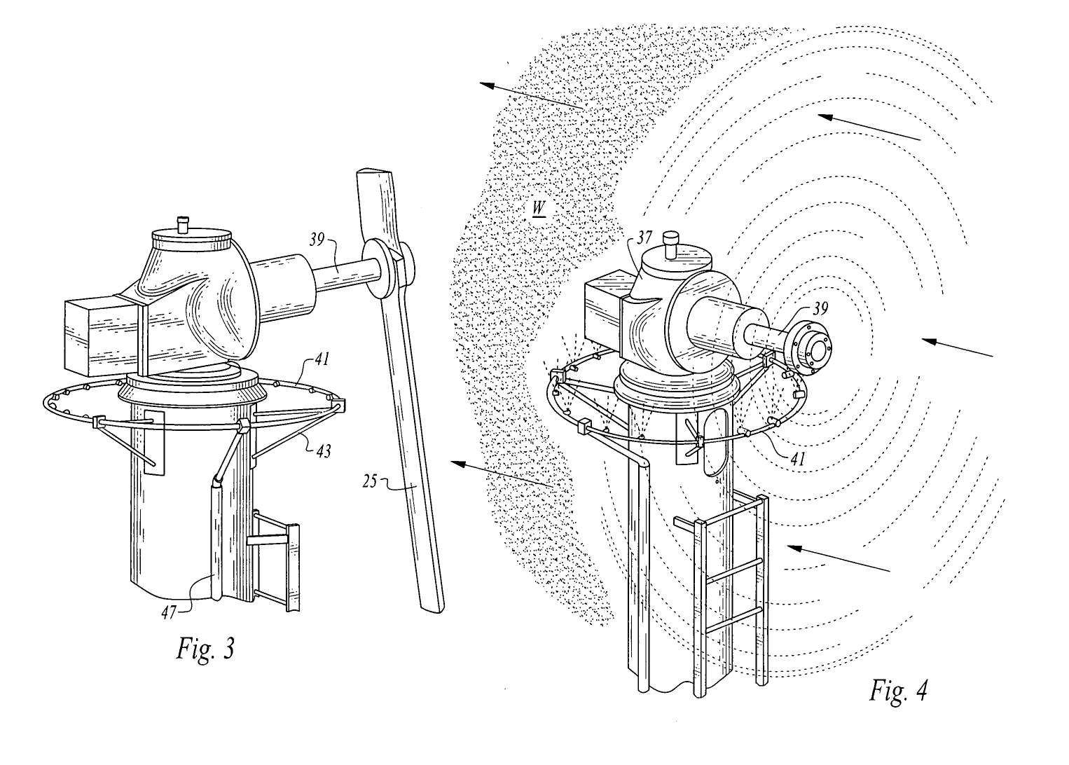

The ring circumscribes the tower and is oriented horizontally beneath the horizontal plane of the transmission head 37 where it is supported by struts 43 [FIG. 3]. Embedded in the ring 41 are a series of upstanding spray nozzles 45. Each of the spray nozzles 45 is so positioned as to emit a relatively fine spray of water droplets upwardly and transverse to the horizontal plane of the air stream W created by the rotating propeller [FIG. 4]. It will be appreciated that a water source must be introduced to the ring 41 and, thus, a water line 47 is provided, which is connected to an appropriate water source via a pump [not shown].

In order to provide power to the spray rig 10, a power source is provided on the platform 12, under a shroud 49. The precise nature of that power source may depend, at least to some extent, on availability at the various locations where the spray rig 10 is needed. However, an internal combustion engine meets the criteria to provide motive power to the rig, whether it be compression ignition or spark ignition. A fuel supply is conveniently stored in a tank S which fits comfortably on the platform 12. By using this power source, this spray rig can go anywhere. The power source may be used to drive both the water pump and the propeller 25.

It will be helpful in understanding the invention to visit it in operation.

Once an appropriate location has been determined, the spray rig 10 is hitched to a suitable tow vehicle by means of tongue T secured to the platform 12, and, with wheels attached, the spray rig is towed to its appointed location, where the outriggers 16 are extended and the levelers 18 are adjusted to level the platform 12.

Where the function of the rig is the cooling of animals, e.g., dairy cows, an effective rig includes a tower 21 of approximately 21 feet to the center of the stub shaft. The height of the tower 21 accommodates a propeller of 16+ feet. The tubular ring in this particular arrangement is about 30 to 36 inches in diameter and is situate approximately 8 to 12 inches beneath the centerline of the stub shaft.

It is contemplated that a 100 hp internal combustion engine will be provided on the platform which is connected in driving relation to the transmission head to rotate the transmission head 37 360° about a vertical axis, while simultaneously driving the propeller 25 at speeds up to 590 rpm. By using a fully contained power source, the need for an external connection is avoided. Water supplied to the tubular ring is emitted from the spray nozzles 45 into the windstream W, thereby carrying the water droplets outwardly in a radius of 150 to 300 feet from the tower. Thus, an area of more than 283,000 square feet can potentially be serviced.

It will be appreciated that by adjusting the engine's throttle, the area covered by the spray may be varied to fit the location. Moreover, the dimensions of the rig may likewise be varied to accommodate the particular contemplated use, all without departure from the invention.

When its work is done, the wheels 52 are remounted to the platform; the upper and lower tower elements are separated at their flanges 32, 33 and the upper tower element is laid over on the support 53. The outriggers are retracted, and the spray rig 10 is ready for storage or movement to a new locale.

Having now described a preferred embodiment of the present invention, it will be appreciated by those skilled in the art that several of the parameters described may be varied to suit a particular use, and those variations are within the contemplation of the invention as described in the accompanying claims wherein:

1. A spray rig, said spray rig being structured to be capable of being moved to any desired location;
said spray rig being mounted on a platform; a tower, said tower being supported vertically on said platform, and said tower terminating in a transmission head, said transmission head being rotatable on a vertical axis through 360 degrees;
a stub shaft extending outwardly from said transmission head, a propeller, said propeller being mounted on said stub shaft in a vertical orientation and rotatable to create a wind stream in a plane substantially parallel with said tower;
a tubular ring mounted to said tower beneath said transmission head, a plurality of spray nozzles, said spray nozzles secured in spaced relation about said tubular ring; a water spray, said water being supplied to said tubular ring under pressure; a source of motive power drivingly connected to said transmission head to simultaneously rotate said transmission head about a vertical axis and drive said stub shaft to drive said propeller.

2. The spray rig of claim 1, wherein said spray rig being sized to blanket an area with water spray over a diameter of 300 to 400 feet.

3. The spray rig of claim 1, wherein said spray nozzles are positioned to emit a water spray into the wind stream created by said propeller.

4. The spray rig of claim 1, wherein said tubular ring is disposed beneath said transmission head.

5. The spray rig of claim 1, wherein said tubular ring circumscribes said tower and is oriented to be parallel with said wind stream.

6. The spray rig of claim 2, wherein said spray nozzles are positioned to emit a water spray into the wind stream created by said propeller.

7. The spray rig of claim 2, wherein said tubular ring is disposed beneath said transmission head.

8. The spray rig of claim 3, wherein said tubular ring is disposed beneath said transmission head.

9. A spray rig, said spray rig being structured to be capable of being moved to any desired location;
said spray rig being mounted on a platform; a tower, said tower being supported vertically on said platform, and said tower terminating in a transmission head, said transmission head being rotatable on a vertical axis through 360 degrees;
a stub shaft extending outwardly from said transmission head, a propeller, said propeller being mounted on said stub shaft in a vertical orientation and rotatable to create a wind stream in a plane substantially transverse to the said tower;
a tubular ring mounted to said tower beneath said transmission head, a plurality of spray nozzles, said spray nozzles secured in spaced relation about said tubular ring; a water spray, said water being supplied to said tubular ring under pressure; a source of motive power drivingly connected to said transmission head to simultaneously rotate said transmission head about a vertical axis and drive said stub shaft to drive said propeller; outriggers mounted to said platform, said outriggers being selectively moved laterally outwardly from said platform to stabilize and position said platform in a horizontal attitude; and removable wheels extending outwardly from said platform to permit transportation of said spray rig to a desired location, said wheels being selectively removed to affix the position of said spray rig.

10. The spray rig of claim 9, wherein said spray rig being sized to blanket an area with water spray over a diameter of 300 to 400 feet.

11. The spray rig of claim 9, wherein said spray nozzles are positioned to emit a water spray into the wind stream created by said propeller.

12. The spray rig of claim 9, wherein said tubular ring is disposed beneath said transmission head.

13. The spray rig of claim 9, wherein said tubular ring circumscribes said tower and is oriented to be parallel with said wind stream.

14. The spray rig of claim 9, wherein said outriggers are equipped with levelers to level said platform.
